(19) United States
(12) Patent Application Publication
(10) Pub. No.: US 2011/0291930 A1
(43) Pub. Date: Dec. 1, 2011

(54) ELECTRONIC DEVICE WITH TOUCH INPUT FUNCTION AND TOUCH INPUT METHOD THEREOF

(75) Inventor: PENG WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/916,590

(22) Filed: Oct. 31, 2010

(30) Foreign Application Priority Data
May 26, 2010 (CN) 201010183536.3

(51) Int. Cl. G09G 5/08; G06F 3/041

(52) U.S. Cl. 345/163; 345/173

(57) ABSTRACT

An electronic device includes a touch input unit, a memory and a processing unit. The memory stores a table recording relationships between different time ranges and different functions executed by the electronic device. In the table, each time range corresponds to a function. The processing unit records the duration of receiving touch signals from a touch point of the touch input unit, searches the table to determine which time range the determined duration falls within, determines the function the determined duration corresponds to if the determined duration falls within one time range, and executes the determined function. The present disclosure also provides a related touch input method.

### BACKGROUND

1. Technical Field

The present disclosure relates to electronic devices and input methods thereof and, particularly, to an electronic device with touch input function and a touch input method thereof.

2. Description of Related Art

A conventional touch pad, for example a touch pad on a notebook computer, can control the movement of a displayed cursor, but cannot execute a right key function like a function executed by a right mouse key. Additional keys need to be configured, causing the structure of electronic devices to be more complex.

Therefore, it is desirable to provide a new electronic device with touch input function to overcome the above-mentioned shortcomings.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an electronic device in accordance with an exemplary embodiment.

FIG. 2 is a flowchart of a touch input method in accordance with an exemplary embodiment.

### DETAILED DESCRIPTION

Embodiments of the present disclosure will now be described in detail below, with reference to the accompanying drawings.

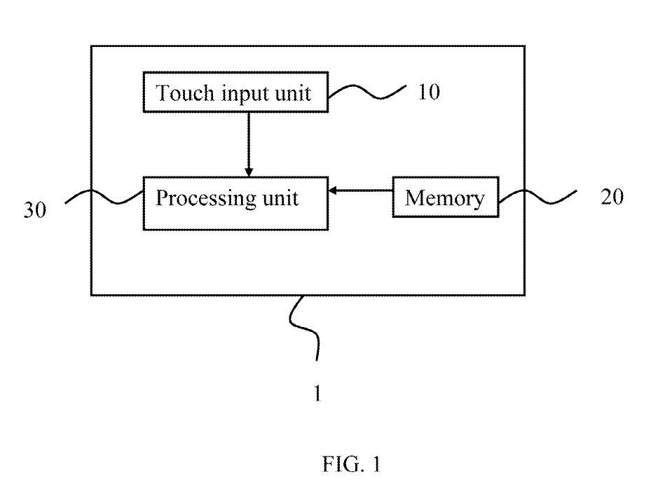

Referring to FIG. 1, an electronic device 1 includes a touch input unit 10, a memory 20, and a processing unit 30. The touch input unit 10 and the memory 20 are electrically connected to the processing unit 30. In this embodiment, the electronic device 1 is a notebook computer. In an alternative embodiment, the electronic device 1 may be such devices as a mobile phone, or a digital photo frame, etc.

The touch input unit 10 is configured to generate touch signals in response to user inputs. In this embodiment, the touch input unit 10 is a touch pad. In alternative embodiments, the touch input unit 10 may be a touch screen.

The memory 20 stores a table for recording relationships between time ranges and functions to be executed by the electronic device 1. In the table, each time range corresponds to a function. In this embodiment, the table records a first time range and a second time range. The first time range corresponds to a left key function like a function executed by a left mouse key, and the second time range corresponds to a right key function like a function executed by a right mouse key.

The processing unit 30 is configured to record the duration of receiving the touch signals from the touch input unit 10, search the table to determine which time range the determined duration falls within, and determine the function to be executed corresponding to the determined duration if the determined duration falls within one time range. The processing unit 30 is further configured to execute the determined function.

In this embodiment, if the duration of receiving the touch signals, namely the duration of touching a touch point of the touch input unit 10, falls within the first time range, the processing unit 30 executes the left key function. If the duration of touching a touch point of the touch unit 10 falls within the second time range, the processing unit 30 executes the right key function. Therefore, with such configuration, there is no need to configure a left key and a right key for the touch input unit 10 similar to a conventional touch pad of a notebook computer, which causes the touch input unit 10 to be more neat.

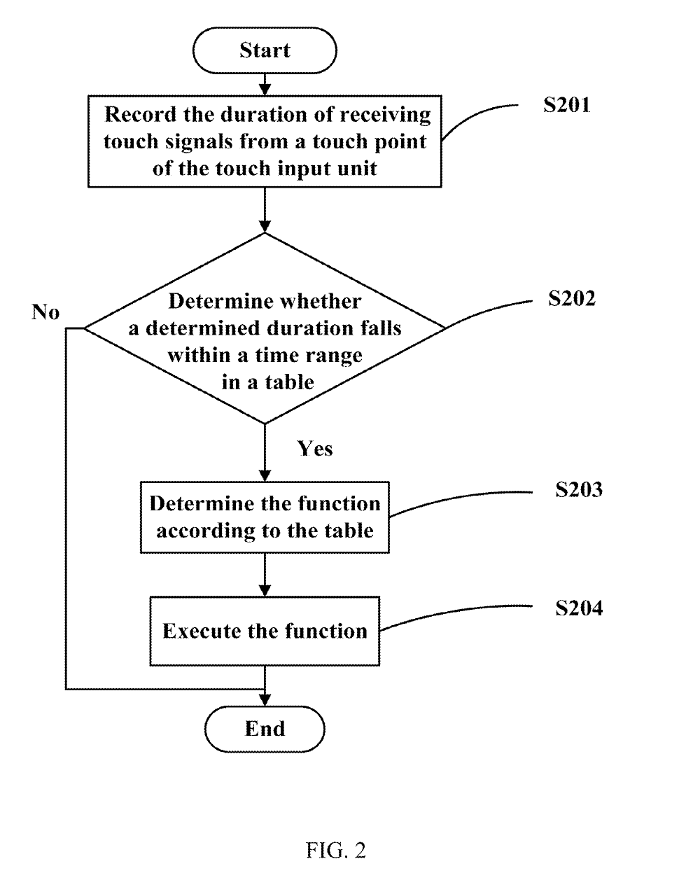

FIG. 2 is a flowchart of a touch input method in accordance with an exemplary embodiment.

In step S201, the processing unit 30 records the duration of receiving the touch signals from a touch point of the touch input unit 10.

In step S202, the processing unit 30 determines whether the determined duration falls within a time range of the table. If the determined duration falls within one time range, the procedure goes to step S203.

In step S203, the processing unit 30 determines the function to be executed corresponding to the determined duration according to the table.

In step S204, the processing unit 30 executes the determined function.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch input unit configured to generate touch signals in response to user inputs;
a memory storing a table recording relationship between time ranges and functions to be executed by the electronic device; and
a processing unit configured to:
record the duration of receiving the touch signals from the touch input unit;
search in the table to determine which time range the determined duration falls within;
determine a function corresponding to the determined duration according to the table if the determined duration falls within one of the time ranges; and
execute the determined function.

2. The electronic device according to claim 1, wherein the touch input unit is a touch pad, the time ranges comprises a first time range and a second time range, the first time range corresponds to a left key function, and the second time range corresponds to a right key function.

3. The electronic device according to claim 2, wherein the electronic device is a notebook computer.

4. The electronic device according to claim 1, wherein the touch input unit is a touch screen.

5. A touch input method applied in an electronic device, the electronic device comprising a memory and a touch input unit, the memory storing a table recording relationship between time ranges and functions executed by the electronic device, each of the time ranges corresponding to one of the functions, the method comprising:
recording duration of receiving touch signals from the touch input unit;
determining whether the determined duration falls within one of the time ranges;
determining a function corresponding to the determined duration according to the table if the determined duration falls within one of the time ranges; and
executing the determined function.

6. The method as described in claim 5, wherein the time ranges comprises a first time rang and a second time range, the first time range corresponds to a left key function like a function executed by a left mouse key, and the second time range corresponds a right key function like a function executed by a right mouse key.
